(19) United States
(12) Patent Application Publication
(10) Pub. No.: US 2006/0076054 A1
(43) Pub. Date: Apr. 13, 2006

(54) Liquid draining valve structure

(76) Inventor: Jen-Pen Chang, Wuri Shiang (TW)

Correspondence Address: BRUCE H. TROXELL, SUITE 1404, 5205 LEESBURG PIKE, FALLS CHURCH, VA, 22041, US

(21) Appl. No.: 10/959,157

(22) Filed: Oct. 7, 2004

(51) Int. Cl. F16T 1/00

(52) U.S. Cl. 137/181

(57) ABSTRACT

A liquid draining valve structure installable on an air reserving apparatus such as a cylinder of an air compressor or a high-pressure air reservoir. The liquid draining valve includes a shaft sleeve lockable with a liquid outlet of the air reserving apparatus, a valve body connected with the shaft sleeve and having a chamber and a drainpipe connector communicating with the shaft sleeve and a ball body disposed in the chamber for blocking a path communicating the shaft sleeve with the chamber and the drainpipe connector. Even in a not used state, the ball body is still responsive to the liquid entering the chamber to automatically float and displace for unblocking the path. Therefore, without high pressure, the liquid can still flow from the chamber to the drainpipe connector and automatically drain out.

### BACKGROUND OF THE INVENTION

The present invention is related to an improved automatic water draining valve, and more particularly to a liquid draining valve including a ball body which can automatically float and displace for draining out the remaining water.

A conventional liquid draining valve is applied to the pipeline system for compressing air, such as air compressor, air reservoir and air compressor filter. The liquid draining valve serves to drain the condensed liquid in the high-pressure air source for reducing possibility of malfunction or rusting of the apparatus caused by humidity. Taiwanese Patent Application No. 91205328 discloses an automatic water-draining valve for air compressor. Taiwanese Patent Application No. 83213798 discloses an automatic water-draining apparatus for air compressor. In the above Patent Applications, an electromagnetic valve is used to control the water-draining valve or a spring set and a cooperative linkage are used to control the water-draining valve.

However, it is known by those skilled in this field that such automatic water-draining valve has complicated structure. Moreover, the electronic elements of such valve must be always in a standby state. This is not economic and energy is wasted.

In operation of the air compressor, due to the pressure of the air compressor, the draining valve is controlled to automatically drain the liquid produced in the air compressor. When the air compressor stops operating, generally an operator can manually operate the draining valve to drain the remaining liquid. However, in practice, it often takes place that the operator forgets to drain the liquid remaining in the air reservoir after the work is finished.

### SUMMARY OF THE INVENTION

It is therefore a primary object of the present invention to provide an improved liquid draining valve structure installable on an air reserving apparatus such as a cylinder of an air compressor or a high-pressure air reservoir. The liquid draining valve includes a shaft sleeve lockable with a liquid outlet of the air reserving apparatus and a valve body connected with the shaft sleeve and having a chamber and a drainpipe connector communicating with the shaft sleeve. A ball body is disposed in the chamber for blocking a path communicating the shaft sleeve with the chamber and the drainpipe connector. Even in a not used state, the ball body is still responsive to the liquid entering the chamber to automatically float and displace for unblocking the path. Therefore, without high pressure, the liquid can still flow from the chamber to the drainpipe connector and automatically drain out.

It is a further object of the present invention to provide the above liquid draining valve in which the drainpipe connector and a horizontal reference axis of the valve body contain an angle. Therefore, the drainage of the liquid from the drainpipe connector can be speeded.

The present invention can be best understood through the following description and accompanying drawings wherein:

### BRIEF DESCRIPTION OF THE DRAWINGS

FIG. 1 is a perspective assembled view of a preferred embodiment of the present invention;

FIG. 2 is a perspective exploded view of the embodiment of FIG. 2;

FIG. 3 is a sectional assembled view of the liquid draining valve of FIG. 1 and an air reservoir;

FIG. 4 is a sectional view according to FIG. 3, showing the operation of the liquid draining valve under pressure;

FIG. 5 is a sectional view according to FIG. 3, showing the operation of the liquid draining valve free from any pressure;

FIG. 6 is a sectional view of another embodiment of the present invention;

FIG. 7 is a sectional view of still another embodiment of the present invention;

FIG. 8 is a sectional view according to FIG. 7, showing the operation of the liquid draining valve under pressure; and

FIG. 9 is a sectional view according to FIG. 7, showing the operation of the liquid draining valve free from any pressure.

### DETAILED DESCRIPTION OF THE PREFERRED EMBODIMENTS

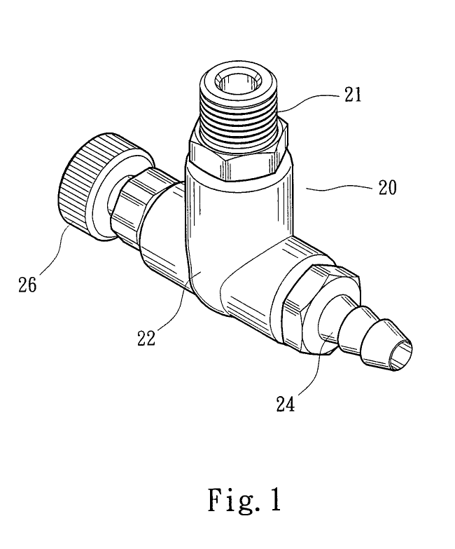

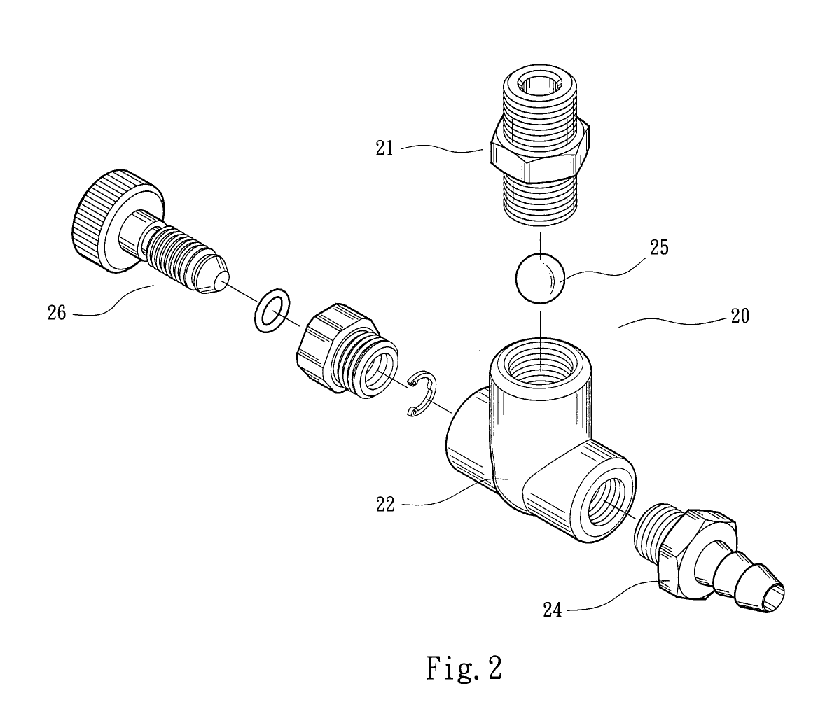

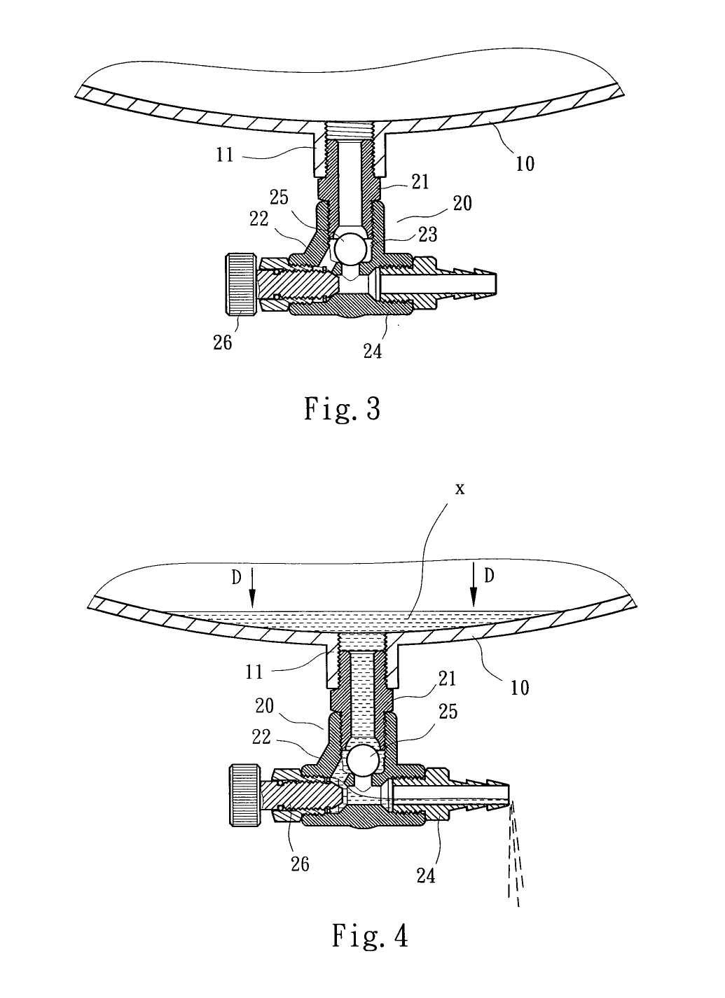

Please refer to FIGS. 1, 2 and 3. The liquid draining valve 20 of the present invention is installable on an air reserving apparatus such as a cylinder of an air compressor or a high-pressure air reservoir. The liquid draining valve 20 includes a shaft sleeve 21 lockable with a liquid outlet 11 of the air reservoir 10 and a valve body 22 connected with the shaft sleeve 21. The valve body 22 has a chamber 23 and a drainpipe connector 24 communicating with the shaft sleeve 21. In this embodiment, a ball body 25 (made of floatable material or non-floatable material) is disposed in the chamber 23 for blocking the path communicating the shaft sleeve 21 with the chamber 23 and the drainpipe connector 24 as shown in FIG. 3.

Referring to FIG. 4, a manually operable switch 26 is mounted on the other side of the valve body 22 opposite to the drainpipe connector 24. When condensed liquid x exists in the air compressor 10, an operator can operate the switch 26 to move backward or toward the left of FIG. 4. At this time, the shaft sleeve 21, chamber 23 and drainpipe connector 24 form a free passage, permitting the liquid x to drain out from the drainpipe connector 24 as shown in FIG. 4.

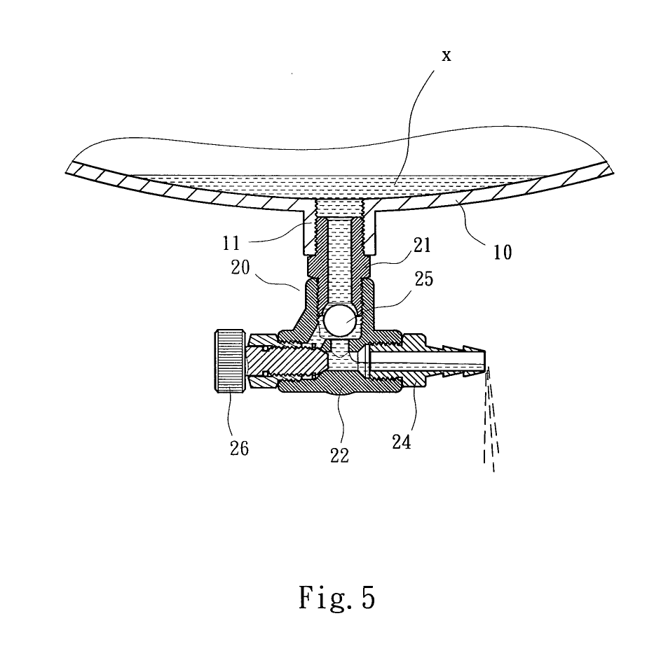

Referring to FIG. 5, when the air compressor 10 is not operated, in case the operator forgets to exhaust the liquid remaining in the air compressor 10 after the work is finished, the ball body 25 is responsive to the liquid x entering the chamber 23 to automatically float and displace for unblocking the path. Therefore, in a state free from any pressure, the liquid x can flow from the chamber 23 into the drainpipe connector 24 to automatically drain out.

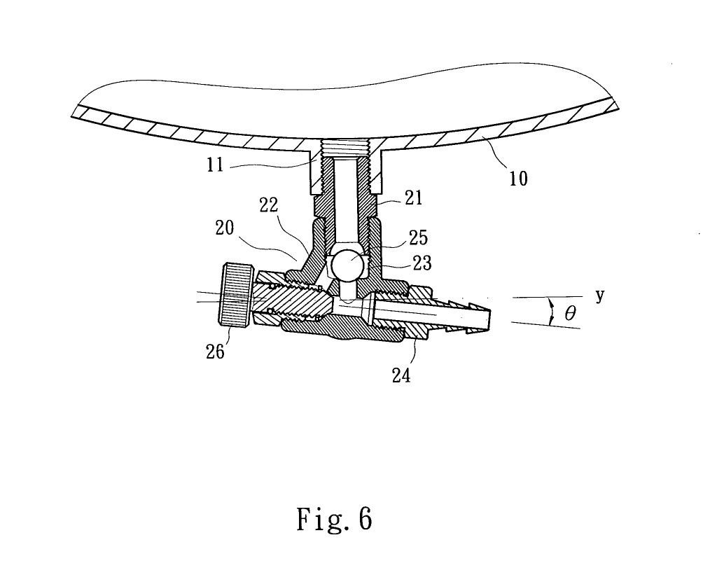

FIG. 6 shows another embodiment of the present invention, in which the drainpipe connector 24 and a horizontal reference axis y of the valve body 22 contain an angle θ. Accordingly, the drainpipe connector 24 is inclined downward, whereby the drainage of the liquid x from the drainpipe connector 24 can be speeded.

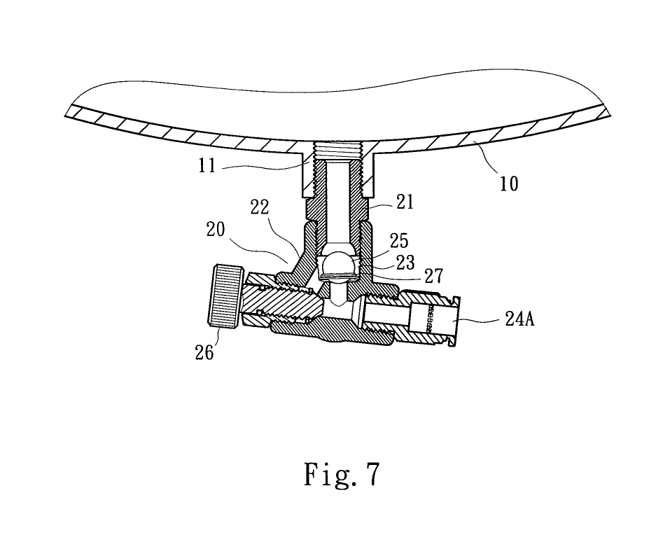

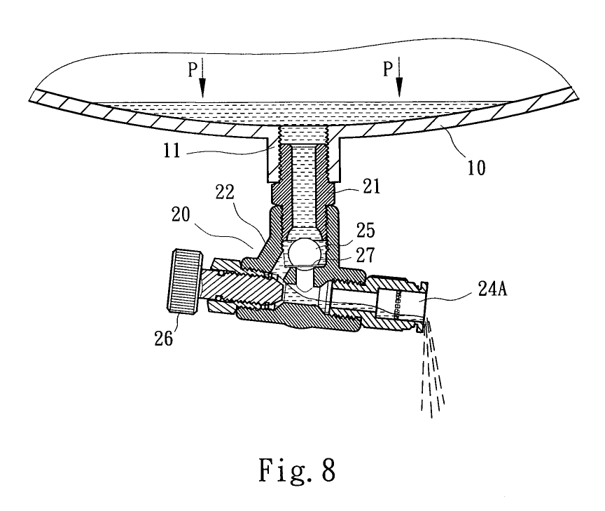

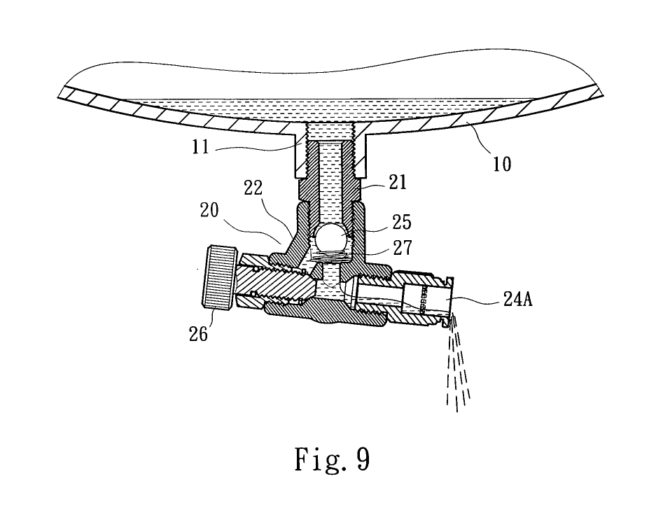

FIGS. 7 to 9 show still another embodiment of the present invention, in which a balancing spring 27 is disposed between the ball body 25 (preferably made of non-floatable material) and the exit of the chamber 23 of the valve body 22. The balancing spring 27 is compressed under the ball body 25 for supporting the same. In normal state, the balancing spring 27 serves to offset most of the weight of the ball body 25. Accordingly, when a slight pressure is produced in the air reservoir 10, the ball body 25 is made move downward to block the exit of the chamber 23. Reversely, in a state free from any pressure, only in the case that little condensed liquid x accumulates in the air reservoir 10 and the chamber 23, the ball body 25 can be easily pushed to unblock the exit. Therefore, little remaining water can be still effectively drained so as to ensure the dryness in the air reservoir 10. In this embodiment, the ball body 25 can be more sensitively and effectively operated.

In addition, the drainpipe connector 24 can be any of the fast connectors 24A as shown in FIGS. 7 to 9 for convenient and quick connection.

The above embodiments are only used to illustrate the present invention, not intended to limit the scope thereof. Many modifications of the above embodiments can be made without departing from the spirit of the present invention.

What is claimed is:

1. A liquid draining valve structure installable on an air reserving apparatus such as a cylinder of an air compressor or a high-pressure air reservoir, the liquid draining valve comprising:
a shaft sleeve lockable with a liquid outlet of the air reserving apparatus;
a valve body connected with the shaft sleeve, the valve body having a chamber and a drainpipe connector communicating with the shaft sleeve; and
a ball body disposed in the chamber for blocking a path communicating the shaft sleeve with the chamber and the drainpipe connector, whereby even when the air reserving apparatus is free from any pressure, the ball body is still responsive to the liquid entering the chamber to automatically float and displace for unblocking the path, permitting the liquid to flow from the chamber to the drainpipe connector and automatically drain out.

2. The liquid draining valve structure as claimed in claim 1, wherein a manually operable switch is mounted on the other side of the valve body opposite to the drainpipe connector.

3. The liquid draining valve structure as claimed in claim 1, wherein the drainpipe connector and a horizontal reference axis of the valve body contain an inclination angle.

4. The liquid draining valve structure as claimed in claim 2, wherein the drainpipe connector and a horizontal reference axis of the valve body contain an inclination angle.

5. The liquid draining valve structure as claimed in claim 1, wherein a balancing spring is disposed between the ball body and an exit of the chamber of the valve body, the balancing spring serving to offset most of the weight of the ball body.

6. The liquid draining valve structure as claimed in claim 2, wherein a balancing spring is disposed between the ball body and an exit of the chamber of the valve body, the balancing spring serving to offset most of the weight of the ball body.

7. The liquid draining valve structure as claimed in claim 3, wherein a balancing spring is disposed between the ball body and an exit of the chamber of the valve body, the balancing spring serving to offset most of the weight of the ball body.

8. The liquid draining valve structure as claimed in claim 4, wherein a balancing spring is disposed between the ball body and an exit of the chamber of the valve body, the balancing spring serving to offset most of the weight of the ball body.

9. The liquid draining valve structure as claimed in claim 1, wherein the ball body is made of floatable material.

10. The liquid draining valve structure as claimed in claim 2, wherein the ball body is made of floatable material.

11. The liquid draining valve structure as claimed in claim 3, wherein the ball body is made of floatable material.

12. The liquid draining valve structure as claimed in claim 4, wherein the ball body is made of floatable material.

13. The liquid draining valve structure as claimed in claim 5, wherein the ball body is made of floatable material.

14. The liquid draining valve structure as claimed in claim 6, wherein the ball body is made of floatable material.

15. The liquid draining valve structure as claimed in claim 7, wherein the ball body is made of floatable material.

16. The liquid draining valve structure as claimed in claim 8, wherein the ball body is made of floatable material.

17. The liquid draining valve structure as claimed in claim 5, wherein the ball body is made of non-floatable material.

18. The liquid draining valve structure as claimed in claim 6, wherein the ball body is made of non-floatable material.

19. The liquid draining valve structure as claimed in claim 7, wherein the ball body is made of non-floatable material.

20. The liquid draining valve structure as claimed in claim 8, wherein the ball body is made of non-floatable material.
